(19) United States
(12) Patent Application Publication
(10) Pub. No.: US 2016/0283990 A1
(43) Pub. Date: Sep. 29, 2016

(54) Apparatus, System, Method, Computer Program, and Computer Program Product For Generating Activity Information For a Cell

(71) Applicant: TELEFONAKTIEBOLAGET L M ERICSSON (PUBL), Stockholm (SE)

(72) Inventors: Simon MORITZ, Stockholm (SE); Maria GERONTINI, Solna (SE)

(73) Assignee: Telefonaktiebolage LM Ericsson (publ), Stockholm (SE)

(21) Appl. No.: 15/031,967

(22) PCT Filed: Oct. 8, 2013
(86) PCT No.: PCT/SE2013/051181

§ 371 Date: Apr. 25, 2016

(51) Int. Cl. G06Q 30/02; H04W 4/02

(52) U.S. Cl. CPC G06Q 30/0282; H04W 4/021

(57) ABSTRACT

A method for generating activity information for a cell, comprising for each cell identifier included in a set of cell identifiers, storing (304) meta-data concerning a cell; for at least a subset of said set of cell identifiers, storing (306) activity information, determining (308) that an amount of activity information associated with a first cell identifier is less than a threshold activity amount; using (310) said meta-data and meta-data associated with other cell identifiers to determine a group of one or more cells that are similar to the cell identified by the first cell identifier; for each cell included in the group of similar cells, obtaining (312) the activity information associated with the cell identifier that identifies the similar cell; generating (314) activity information for the first cell identifier using the obtained activity information; and storing (316) the activity information. Apparatuses, computer programs and computer program products are also disclosed.

### TECHNICAL FIELD

This disclosure relates generally to apparatuses, methods, computer programs and computer program products for generating activity information for a cell.

### BACKGROUND

As used herein the term “cell” is used broadly to encompass any extent of space or surface (e.g., an area, a location, a telecommunications network cell).

Location based services (LBSs) are services that provide information to a user and/or perform a task for the user based on the user's location. LBSs are becoming extremely popular. For example, U.S. Patent Publication No. 2012/0290434 describes in one embodiment a recommendation system that is configured to select items to recommend to a user based on the user's location context. This increase in popularity is being driven partly by the fact that the majority of today's communication devices (e.g., smartphones) contain a Global Positioning System (GPS) receiver (and/or other means) that enables the communication device to accurately determine the device's position. Many LBSs have been developed that can provide a recommendation to a user based on user's location and preferences. For instance, a recommendation system can select applications (“apps”) to recommend to a user based on the user's current location and historical activity information regarding apps that other users used at or near that location. Thus, the recommendation system may recommend to a user in a train station a particular train schedule app because many other users in the train station used that particular app within the last month.

A drawback of such a recommendation system is that the database of historical activity information on which its recommendations are based may be sparse. For example, for some cells, the database may not include any historical activity information on which to base a recommendation for a user.

### SUMMARY

The present disclosure discloses apparatuses, methods, computer programs and computer program products that are designed to overcome the above described drawback. More specifically, the present disclosure discloses apparatuses, methods, computer programs and computer program products for generating activity information for a cell, such as a cell for which historical activity information is lacking. Advantages provided by the technical improvements described herein include, but are not limited to: lessening the impact of the classic sparse data problem experienced by many data mining systems; it can be used as the basis for context-awareness recommendation systems, such as app predictions/recommendations; it can be used to make an app coverage map when there are limited data collectors (terminal recordings); it's useful for location based marketing; it can be used to predict future activity; it can be used to create profiling for various locations; and it can be used for geospatial analysis tasks

In one aspect, a method for generating activity information for a cell is disclosed. In some embodiments, the method is performed by a data processing system comprising a processor. The method includes, for each cell identifier included in a set of cell identifiers storing meta-data (e.g., a cell type value, a set of usage intensity values, etc.) concerning a cell identified by the cell identifier so that the meta-data is associated with the cell identifier. For at least a subset of the set of cell identifiers, the method further includes storing activity information so that the activity information is associated with the cell identifier, the activity information being related to activities that have occurred within the cell identified by the cell identifier. The method also includes determining that an amount of activity information associated with a first cell identifier included in the set of cell identifiers is less than a threshold activity amount and using the meta-data associated with the first cell identifier and meta-data associated with other cell identifiers included in the set of cells to determine a group of one or more cells that are similar to the cell identified by the first cell identifier. For each cell included in the group of similar cells, the method also includes obtaining the activity information associated with the cell identifier that identifies the similar cell; generating activity information for the first cell identifier using the obtained activity information; and storing the generated activity information so that it is associated with the first cell identifier.

In this manner, activity information can be generated for a cell and associated with a cell. This is highly advantageous because a recommendation system can then use the generated activity information to provide intelligent recommendations to users located in the cell, even if there is no actual historical activity information for the cell. Without this method, the recommendation system may not have sufficient activity information to make such an intelligent recommendation.

In some embodiments, each cell identifier included in the set of cell identifiers is a character string formed by encoding a geographic coordinate.

In the some embodiments, the method also includes receiving from a wireless communication device (WCD) an application activity item, the application activity item comprising: a) an application identifier identifying an application used by a user of the WCD, b) location information identifying a location of the WCD at the time the user of the WCD used the identified application, and c) a timestamp identifying a point in time at which the user of the WCD used the identified application in the identified location. The method may also include, after receiving the application activity item, using the location information to select from the set of cell identifiers one of the cell identifies; and, after selecting the cell identifier, storing the application identifier and timestamp so that they are associated with the selected cell identifier.

In some embodiments, the obtained activity information comprises: a first value associated with a certain activity that occurred within a first cell included in the group and a second value associated with a certain activity that occurred within a second cell included in the group, and generating the activity information comprises calculating a value using the first and second values.

In some embodiments, the method also includes using the generated activity information to select an item to recommend to a user located in the cell identified by the first cell identifier.

In some embodiments, determining that an amount of activity information associated with the first cell identifier is less than a threshold activity amount consists of determining that no activity information is associated with the first cell identifier.

In some embodiments, the method also includes: determining a likelihood (L) that the cell identified by the first cell identifier has an amount of activity and determining that L exceeds a threshold, and generating activity information for the first cell identifier using the obtained activity information is performed as a result of (1) determining that L exceeds the threshold and (2) determining that an amount of activity information associated with the first cell identifier is less than a threshold activity amount.

In another aspect, the present disclosure describes an apparatus for generating activity information for a cell. In some embodiments, the apparatus includes a data storage system storing a cell database, the cell database for storing: i) a set of cell identifiers, including a first cell identifier, each cell identifier included in the set identifying a cell, ii) for each of the cell identifiers, meta-data concerning the cell identified by the cell identifier so that the meta-data is associated with the cell identifier, and iii) for at least a subset of the cell identifiers, activity information so that the activity information is associated with the cell identifier, the activity information being related to activities that have occurred within the cell identified by the cell identifier. The apparatus also includes a data processing system comprising a processor. The processor is adapted to: determine that an amount of activity information associated with the first cell identifier is less than a threshold activity amount; use the meta-data associated with the first cell identifier and meta-data associated with other cell identifiers included in the set of cells to determine a group of one or more cells that are similar to the cell identified by the first cell identifier; for each cell included in the group of similar cells, obtain the activity information associated with the cell identifier that identifies the similar cell; generate activity information for the first cell identifier using the obtained activity information; and store the generated activity information so that it is associated with the first cell identifier.

In another aspect, the present disclosure describes a computer program for generating activity information for a cell. The computer program comprising computer readable instructions which when run on a data generation system causes the data generation system to: for each cell identifier included in a set of cell identifiers, store meta-data concerning the cell identified by the cell identifier so that the meta-data is associated with the cell identifier; and for at least a subset of the set of cell identifiers, further store activity information so that the activity information is associated with the cell identifier, the activity information being related to activities that have occurred within the cell identified by the cell identifier. The instructions further enable the data generation system to determine that an amount of activity information associated with a first cell identifier included in the set of cell identifiers is less than a threshold activity amount; use the meta-data associated with the first cell identifier and meta-data associated with other cell identifiers included in the set of cells to determine a group of one or more cells that are similar to the cell identified by the first cell identifier; for each cell included in the group of similar cells, obtain the activity information associated with the cell identifier that identifies the similar cell; generate activity information for the first cell identifier using the obtained activity information; and store the generated activity information so that it is associated with the first cell identifier.

In another aspect, a computer program product is provided. The computer program product comprises a non-transitory computer readable medium storing the above described computer program.

### BRIEF DESCRIPTION OF THE DRAWINGS

The accompanying drawings, which are incorporated herein and form part of the specification, illustrate various embodiments.

FIG. 1 illustrates a system in accordance with one embodiment.

FIG. 2 further illustrates a recommendation system according to some embodiments.

FIG. 3 is a flow chart illustrating a process, according to some embodiments, that is performed by a data generation system.

FIG. 4 is a flow chart illustrating a process, according to some embodiments, that is performed by a cell manager component of the data generation system.

FIG. 5 illustrates a set of defined cells.

FIG. 6 is a flow chart illustrating a process, according to some embodiments, that is performed by a data collector component of the data generation system.

FIG. 7 is a flow chart illustrating another process, according to some embodiments, that is performed by the data collector.

FIG. 8 is a flow chart illustrating a process, according to some embodiments, that is performed by an activity estimator component of the data generation system.

FIG. 9 is a flow chart illustrating a process, according to some embodiments, that is performed by a recommendation engine component of a recommendation system.

FIG. 10 is a block diagram of a data generation system in accordance with some embodiments.

FIG. 11 illustrates an embodiment of a data structure of a cell database that may be used to store meta-data such that the meta-data is associated with a cell identifier.

FIG. 12 illustrates an embodiment of a data structure that may be used to store activity information such that it is associated with a cell identifier.

FIG. 13 illustrates an embodiment of a data generation system.

### DETAILED DESCRIPTION

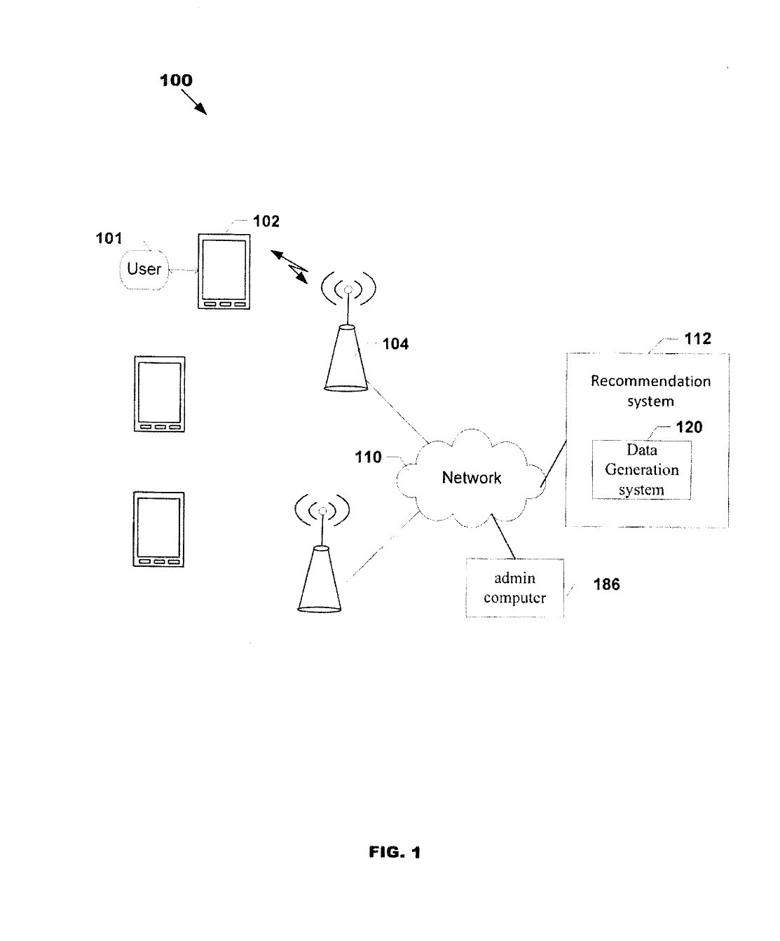

FIG. 1 illustrates a system 100 according to an embodiment of this disclosure. System 100 includes data generation system 120. The data generation system 120 functions to generate activity information for a cell and associate the activity information with the cell. In the embodiment shown, data generation system 120 is a component of a recommendation system 112, but this is not a requirement as data generation system 120 may be a stand-alone system and it may be a component of something other than a recommendation system. As discussed above, data generation system 120 is highly advantageous because, for example, recommendation system 112 can use the activity information generated by data generation system 120 to provide intelligent recommendations to users located in the cell, such as user 101.

For example, consider a user 101 that is in possession of and using a communication device 102 (e.g., a smartphone, computer, tablet, etc.) within a particular cell (e.g., the South Beach neighborhood of Miami Beach). The user may cause the communication device 102 to transmit, via access point 104 (e.g., Wi-Fi access point, base station, etc.) and network 110, a request to an on-line shopping system (not shown) that includes recommendation system 112. In response to the request, the on-line shopping system may generate a page of information containing information the user requested as well as information about an item (e.g., sunglasses) that recommendation system 112 selected to recommend to user 101 based on activity information associated with the cell in which user 101 is located. The activity information could include actual historical activity information (e.g., purchase history information indicating that sunglasses are popular items within the cell) and/or generated activity information (such as assumed or estimated activity information).

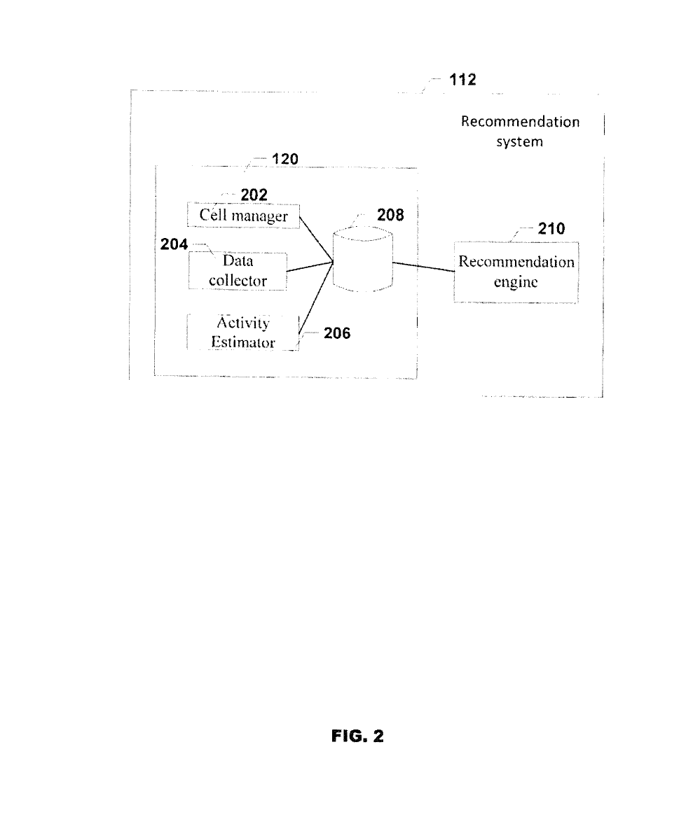

FIG. 2 is a functional block diagram further illustrating recommendation system 112 and data generation system 120 according to some embodiments. In the embodiment shown, data generation system includes a cell manager 202, a data collector 204, an activity estimator 206, and a cell database 208 for storing and organizing information pertaining to cells, such as: cell identifiers (cell ids), cell meta-data (e.g., information describing a cell), and cell activity information (e.g., purchase/use history information identifying items users purchased/used while the users were located in a cell). Recommendation system 112 in the embodiment shown includes a recommendation engine 210 that has access to cell database 208 and that is configured to use information (e.g., activity information) from cell database 208 to select items to recommend to users. Recommendation system 112 may be a monolithic system (e.g., all components execute on the same computer) or a distributed system (i.e., system 112 may comprise two or more computers, which may or may not be collocated, where each computer implements some part of system 112).

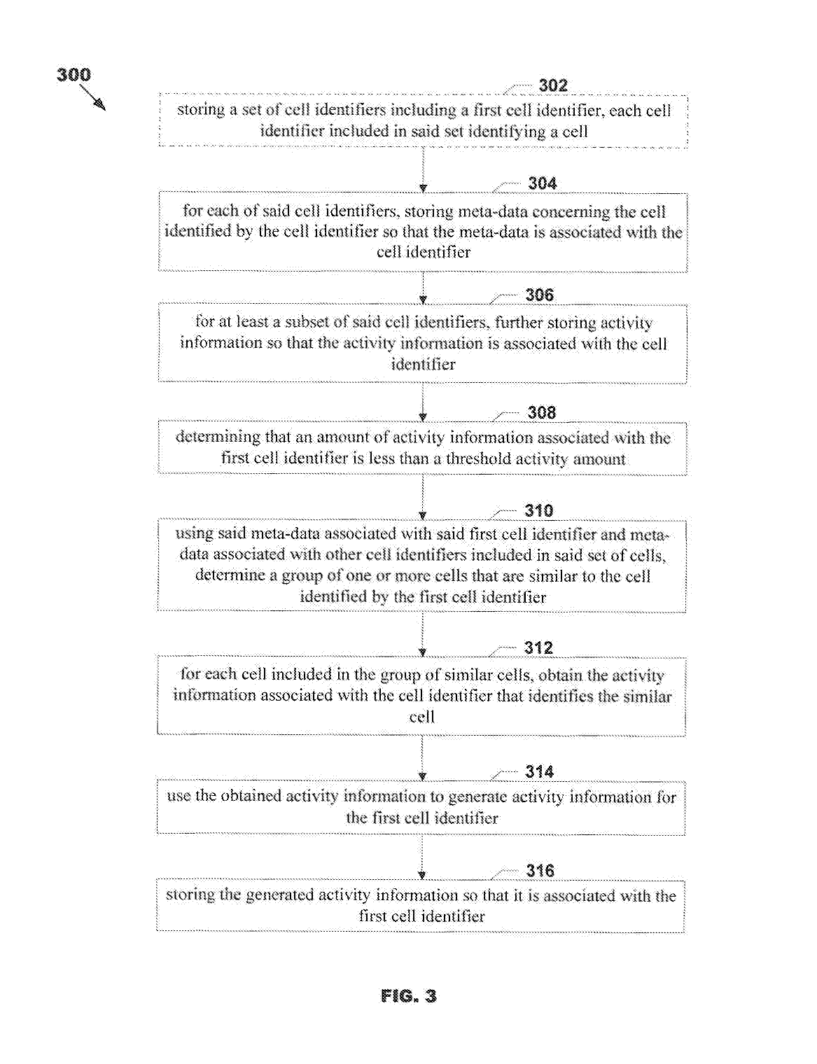

FIG. 3 is a flow chart illustrating a process 300, according to some embodiments, that may be performed by data generation system 120.

Process 300 may begin in step 302, where data generation system 120 stores a set of cell identifiers including a first cell identifier, where each cell identifier included in the set identifies a cell. Data generation system may store the cell identifiers in cell database 208. Step 302 is optional because, in some embodiments, the set of cell identifiers may be stored by another system. In some embodiments, one or more cell identifiers included in the set of cell identifiers is a character string (e.g., a string of letters, numbers, and/or other characters) formed by encoding a geographic coordinate (e.g. pair of geographic coordinate values). For example, in some embodiments, a cell identifier can be a character string formed by a geocode service based on a postal address or a pair of geographic coordinate values (e.g., a latitude and longitude value pair), such as the geocode service available at geohash.org, retrieved on Sep. 19, 2013. In other embodiments, a cell identifier is a telecommunications network cell (or base station) identifier that is used in a cellular telecommunications system. Accordingly, a “cell” can by any arbitrary area, such as an area defined by geographic coordinates as well as an area defined by cells of a cellular telecommunication system.

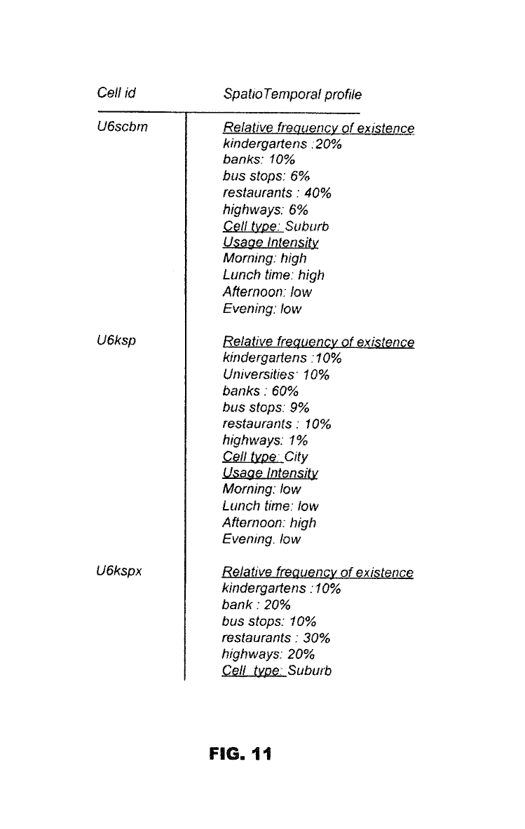

In step 304, for each of the cell identifiers, data generation system 120 obtains and stores meta-data concerning the cell identified by the cell identifier so that the meta-data is associated with the cell identifier. For example, the meta-data concerning the cell may be stored in cell database 208 along with the cell identifier identifying the cell or may be linked to the cell by being stored in another database (not shown) and associated to the cell identifier e.g. by a link/pointer stored in the cell database 208 or in the other database. In some embodiments, the meta-data includes one or more of: a cell type value identifying a cell type (the set of cell types may include: suburban, rural, urban, exurban, city, town, village, café, university, airport, train station, hotel, etc.); and usage intensity information (e.g., a set of a tuples, where each tuple includes a usage intensity value and a time-of-day identifier). Additionally, the meta-data may also contain information identifying the relative frequency of existence of certain objects, business, institutions, etc. For example, the meta-data for a cell having a cell type of “suburb,” may include relative frequency of existence information that identifies the relative frequency of existence of banks, schools, cafes, bus stops within the cell. Referring to FIG. 11, FIG. 11 illustrates a data structure (in this case a table) of cell database 208 that may be used to store meta-data such that the meta-data is associated with a cell identifier. As shown in FIG. 11, cell id U6scbm is associated with a cell type value, usage intensity information, and relative frequency of existence information.

In step 306, for each of at least a subset of the cell identifiers, data generation system 120 further obtains and stores activity information for the cell corresponding to the cell identifier so that the activity information is associated with the cell identifier. That is, the activity information for a cell may be stored in cell database 208 along with the cell identifier identifying the cell and the meta-data for the cell. The activity information is related to activities that have occurred within the cell identified by the cell identifier. In some embodiments the activity information comprises a set of one or more activity items, where each activity item includes an identifier identifying an activity (e.g., an app identifier identifying an app) and a timestamp. An activity item may also include a geographic coordinate or other location information.

In some embodiments, data collector 204 receives from a communication device 102 (e.g., a wireless communication device (WCD)) application activity information (i.e., activity related to use of an app), where the application activity information includes: one or more application activity items. In some embodiments, an application activity item includes: a) an app identifier identifying a specific app, b) location information identifying a location of the WCD at the time the user of the WCD used the identified application, c) a timestamp indicating the date and time of day the app was used. In response to receiving an application activity item from the WCD, data collector 204 may convert the location information included in the item to a cell identifier (using, for example, a service provided by geohash.org) and then perform step 306 (e.g., data collector may store the application activity item (or at some portion thereof) such that it is associated with the cell identifier that was created based on the location information).

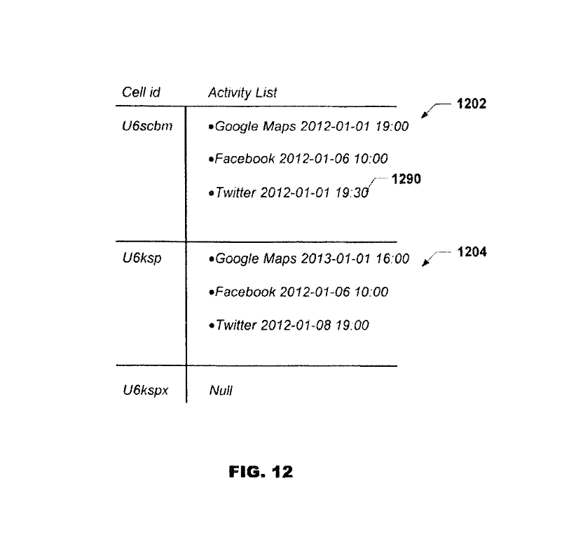

Referring to FIG. 12, FIG. 12 illustrates a data structure (in this case a table) that may be used to store activity information such that it is associated with a cell identifier. As shown in FIG. 12 activity information 1202 is associated with cell id U6scbm and activity information 1204 is associated with cell id U6ksp. As also shown in FIG. 12, no activity information is associated with cell id U6kspx. As further illustrated in FIG. 12, activity information may include one or more activity items (see e.g., activity item 1290). As shown in FIG. 12, activity item 1290 identifies an activity (e.g., usage of a specific app) and incudes a timestamp identifying a date and a time of day. In the example shown, activity item 1290 indicates that some user used twitter within the cell identified by the cell identifier “U6scbm” at 7:30 PM on Jan. 1, 2012.

In step 308, data generation system 120 determines that an amount of activity information associated with the first cell identifier is less than a threshold activity amount. The threshold may be one activity item or any number of activity items. In some embodiments, determining that an amount of activity information associated with the first cell identifier is less than a threshold activity amount consists of determining that no activity information is associated with the cell identifier. In other embodiments, determining that an amount of activity information associated with the first cell identifier is less than a threshold activity amount comprises determining that the number of activity items included in the activity information that satisfy a set of one or more criterions is less than or equal to a threshold amount.

In step 310, data generation system 120, using the meta-data associated with the first cell identifier and meta-data associated with other cell identifiers included in the set of cells, determines a group of one or more cells that are similar to the cell identified by the first cell identifier. In some embodiments, given a threshold Theta between 0 and 1, a pair of points pi; pj are defined to be similar if the following holds: sim(pi; pj) greater or equal to Theta.

In one embodiment, data generation system 120 determines a group of cells that are similar to the first cell by determining neighborhood cells. The neighborhood cells to a given cell could be described by the Euclidian distance between the cells. One way of classifying cells into cluster in this Euclidian space is by calculating K-nearest cells, where the cells are described by geographical place type (P), time (T), context (C) and data type (D). An example method for calculating K-nearest neighbors is using the K-medoids method. It works like the following:

Method 1: K-MEDOIDS

Input: List of top 15 used categories per cell

Output: clustered cells

Begin
Choose k random positions in the input space as medoids
Assign the medoids to those positions

Repeat the following until the medoids stop moving:
for each y non-selected object and x selected object do:
   Calculate the Total Swapping Cost TCyx
   If TCyx<0, x is replaced by y
end for
   Assign each non-selected data point to the nearest medoid

end repeat

Return regions list with corresponding cell indices

In step 312, for each cell included in the group of similar cells, data generation system 120 obtains the activity information associated with the cell identifier that identifies the similar cell. In step 314, data generation system 120 uses the obtained activity information to generate activity information for the first cell identifier. The obtained activity information may include or be used to obtain: a first value associated with a certain activity that occurred within a particular cell included in the group (e.g., a value representing the number of tweets sent by users in the first cell of the group) and a second value associated with the certain activity that occurred within a second cell included in the group (e.g., a value representing the number of tweets sent by users in the second cell of the group). In some embodiments, generating the activity information comprises calculating a value using the first and second values (e.g., averaging the first and second values). In step 316, data generation system 120 stores the generated activity information (e.g., the average value and an identifier of the activity) so that it is associated with the first cell identifier. In embodiments where data generation system 120 does not perform step 302 because another system performs this step, data generation system 120 may accomplish step 316 by transmitting to the another system the generated activity information, whereby the another system stores the generated activity information so that it is associated with the first cell identifier.

In this way, for example, if cell 1 has no activity information associated with it, but cells 2 and 3 do have activity information and cells 2 and 3 are similar to cell 1, then we can assume activity information for cell 1. For instance, consider the following scenario: 5000 tweets were sent by users in cell 2 within the last month; 10000 tweets were sent by users in cell 3 within the last month; and cells 2 and 3 are equally similar to cell 1. In this scenario we can generate pseudo historical activity information for cell 1 by taking an average the number tweets associated with cell 2 and the number of tweets associated with cell 3 and associate that information with cell 1. That is, in this hypothetical scenario the pseudo historical activity information will indicate that 7500 tweets were sent by users in cell 1. In some embodiments, the degree of similarity is taken into account when generating the activity information for cell 1. For instance, if the similarity score between cell 1 and cell 2 is s1 and the similarity score between cell 1 and cell 3 is s2, then we can determine a weighted average for the number of tweets as follows: (s1×5000+s2×10000)/2, and assign this number of tweets to cell 1 for the relevant period (i.e., the last month).

As discussed above, recommendation engine 210 may use the generated activity information to select an item to recommend to a user of a communication device 102 located in the cell identified by the first cell identifier. The recommendation may be sent to the communication device 102 via e.g. a web server being a part of the recommendation system 112 and communicating with the communication device 102 with the help of HTTP (Hypertext Transfer Protocol) messages, like HTTP Get messages and HTTP response messages.

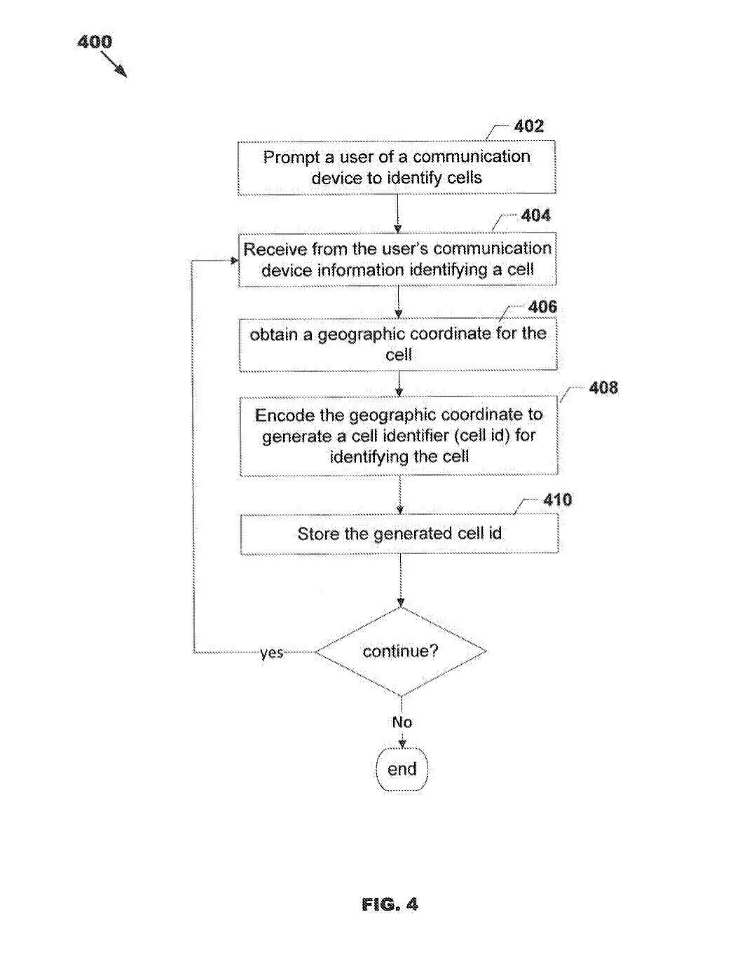

Referring now to FIG. 4, FIG. 4 is a flow chart illustrating a process 400 that may be performed by cell manager 202. Process 400 may begin in step 402, where cell manager 202 Prompt a user of a computing device (e.g., an admin computer 186 or communication device 102) to identify cells. In step 404, cell manager 202 receives from the computing device information identifying a cell.

As discussed above, in some embodiments, the information identifying a cell may include or consists of a one or more geographic coordinates. In other embodiments, the information identifying a cell may be a telecommunications cell identifier that identifies a cell of a cellular telecommunications system.

In the embodiments where the information identifying the cell includes one or more geographic coordinates, the information identifying the cell may consist of i) two or more geographic coordinate values specifying a center point of the cell and ii) a size value identifying a size (e.g., area) of the cell. In other embodiments, such as embodiments in which the cell is a polygon (e.g., a quadrilateral), the information identifying the cell may consist of four geographic coordinates, each geographic coordinate specifying a corner of the cell.

For the sake of illustration, we shall assume that the information identifying the cells includes one or more geographic coordinates.

In step 406, cell manager 202 obtains a geographic coordinate for the cell (e.g., cell manager 202 may determine the geographic coordinate (latitude/longitude values) that defines the center point of the cell if that information was not provided by the user). In step 408, cell manager 202 encodes the obtained geographic coordinate to generate a cell identifier (cell id) for identifying the cell. For example, in step 408, cell manager 202 may use a geohashing service to generate a geohash for the geographic coordinate based on the geographic coordinate values of the geographic coordinate. In step 410, cell manager 202 stores the generated cell id (e.g., the generated cell id may be stored in database 208). Steps 402-410 repeat if the user wishes to define an additional cell.

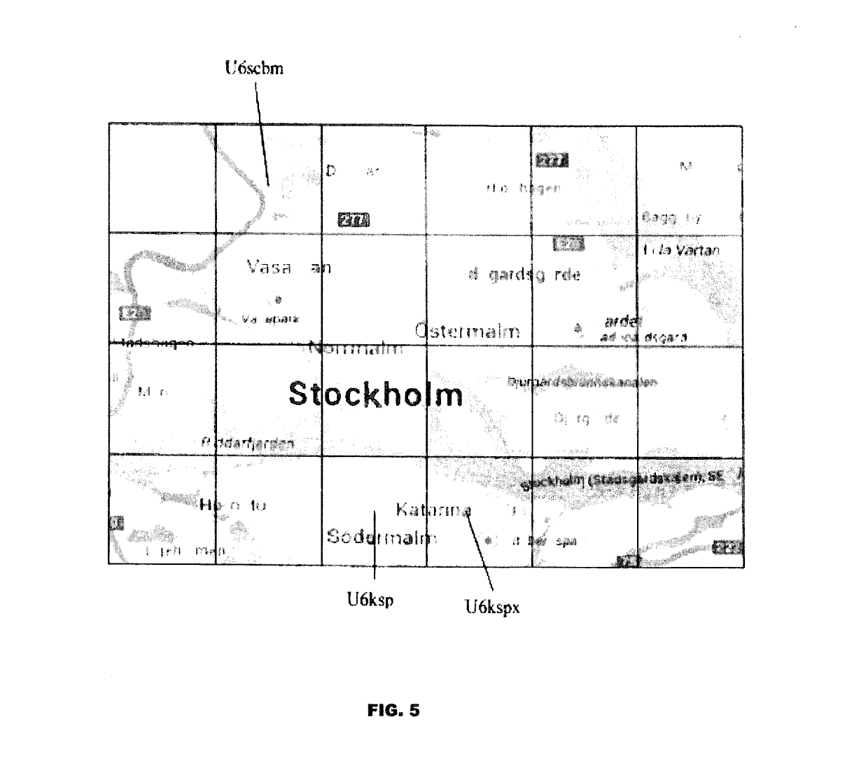

FIG. 5 illustrates an example set of cells that have been identified by a user. As shown in FIG. 5, each cell is associated with a cell id. As shown in FIG. 5, each cell is in the shape of a rectangle, but cells can have any shape and size and should not be confused with “cells” of a cellular communication system that are served by a base station. However, it is possible that a user may identify a set of cells wherein each cell is co-extensive with a different “cell” of a cellular communication system.

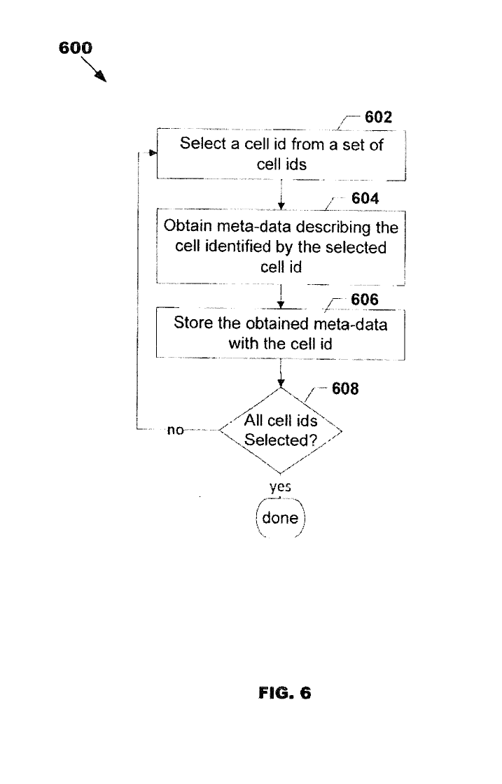

Referring now to FIG. 6, FIG. 6 is a flow chart illustrating a process 600 that may be performed by data collector 204. Process 600 may begin in step 602, where data collector 204 selects a cell id from a set of cell ids (e.g., the cell ids stored in step 410 by cell manager 202). In step 604, data collector 204 obtains meta-data describing the cell identified by the selected cell id. For example, data collector 204 may use the selected cell id to obtain the meta data.

For instance, in some embodiments where the cell id is a geohash, data collector 204 may use the selected cell id to obtain the meta data by sending to a geographic information system (GIS) (such as, for example, Open Street Maps, www.openstreetmap.org, retrieved on Sep. 20, 2013) a query containing the cell id. The GIS may use the cell id included in the query to obtain meta-data associated with the cell-id. Such meta-data may include the above described relative frequency of existence information.

As another example, in other embodiments, data collector 204 may use the selected cell id to obtain the meta data by obtaining a geographic coordinate for the cell and send to the GIS a query containing the geographic coordinate to obtain information concerning an area in which the geographic coordinate is located. Such information may include the above described relative frequency of existence information.

In step 606, data collector 204 stores the obtained meta-data with the cell id (see e.g., FIG. 11 for an example data structure for storing cell ids together with corresponding meta-data). In step 608, data collector 204 determines if all of the cell ids in the set have been selected. If so, the process ends, otherwise it repeats.

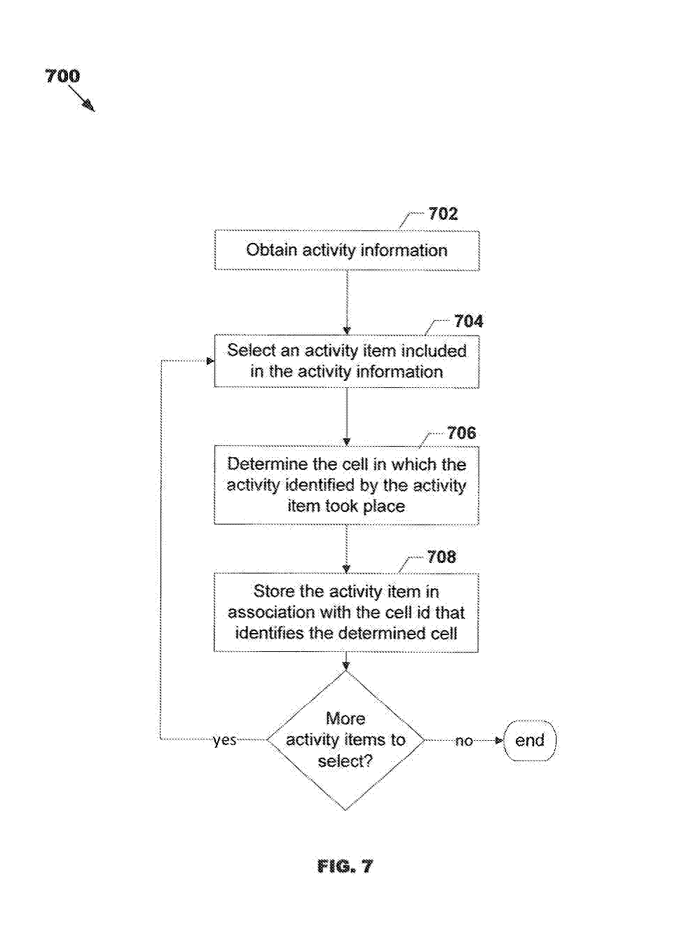

Referring now to FIG. 7, FIG. 7 is a flow chart illustrating another process 700 that may be performed by data collector 204. Process 700 may begin in step 702, where data collector 204 obtains (e.g., receives) activity information. In some embodiments, data collector 204 obtains the activity information by transmitting to a communication device (e.g., communication device 102) a request for activity information stored in the communication device, which request causes the communication to transmit the requested activity information to data collector 204. This is known as a “pull” embodiment. In a “push” embodiment, data collector 204 receives activity from a communication device without having to request it (i.e., the communication device pushes it to data collector 204). In some embodiments, a combination of push and pull is used.

In step 704, after obtaining the activity information, which includes at least one activity item, data collector 204 selects an activity item that is included in the activity information. As discussed above, an activity item may include information identifying an activity (usage of specific app) and a timestamp. In some embodiments, for each activity item included in the set of activity information, the activity information includes location information identifying the location in which the activity was performed.

In step 706, for the selected activity item, data collector 204 uses the location information identifying the location in which the activity was performed to determine the cell in which the activity took place. And in step 708, data collector 204 stores the activity information in association with the cell id that identifies the cell determined in step 706. If not all of the activity items that were included in the obtained activity information have been selected and processed, then the process may repeat, otherwise it may end.

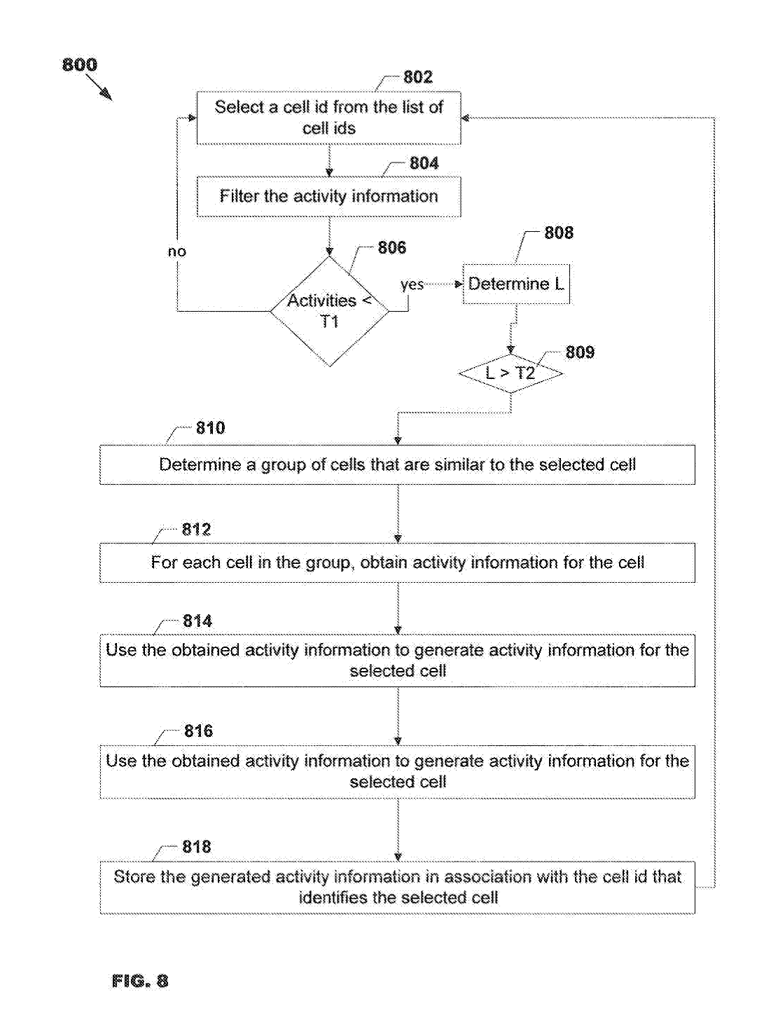

Referring now to FIG. 8, FIG. 8 is a flow chart illustrating a process 800 that may be performed by activity estimator 206. Process 800 may begin in step 802, where activity estimator 206 selects a cell id from a set of cell ids (e.g., the cell ids stored in step 410 by cell manager 202). In step 804, activity estimator 206 filters the activity information associated with the selected cell identifier (assuming such activity information exists for the cell identifier). As discussed above, such activity information includes one or more activity items. In some embodiments, filtering the activity information comprises or consists of selecting only those activity items included in the activity information that meet a set of one or more criterions.

In step 806, activity estimator 206 determines whether an amount of activity information associated with the selected cell identifier is less than a threshold activity amount (T1). T1 may be one activity item or any number of activity items. In some embodiments, determining whether an amount of activity information associated with the selected cell identifier is less T1 consists of determining whether cell database 208 does not contain any activity information associated with the cell identifier. In other embodiments, determining whether an amount of activity information associated with the selected cell identifier is less than T1 comprises determining whether the amount of the filtered activity information is less than T1. For example, determining whether an amount of the filtered activity information is less than T1 comprises determining whether the number of activity items selected in step 804 is less than T1.

In step 808, which is performed as a result of activity estimator 206 determining that an amount of activity information associated with the selected cell identifier is less than T1, activity estimator 206 determines a likelihood (L) of the cell identified by the selected cell identifier having an amount of activity information that exceeds T1. This probability determination may be based on the average amount of activity information that is associated with all cells that are similar to the cell identified by the selected cell identifier.

In step 809, activity estimator 206 determines whether L is greater than a likelihood threshold (T2). If it is not, then the process may proceed back to step 802, otherwise it may proceed to step 810. In step 810, activity estimator 206 determines a group of cells that are similar to the cell identified by the selected cell identifier, as described above with respect to step 310. In step 812 for each cell in the group, activity estimator 206 obtains activity information for the cell (e.g., for each cell in the group, activity estimator 206 retrieves from cell database 208 the activity information associated with the cell identifier that identifies the cell). In step 814, activity estimator 206 uses the obtained activity information to generate activity information for the selected cell, as described above with respect to step 314. In step 812, stores the generated activity information in association with the cell identifier that identifies the selected cell

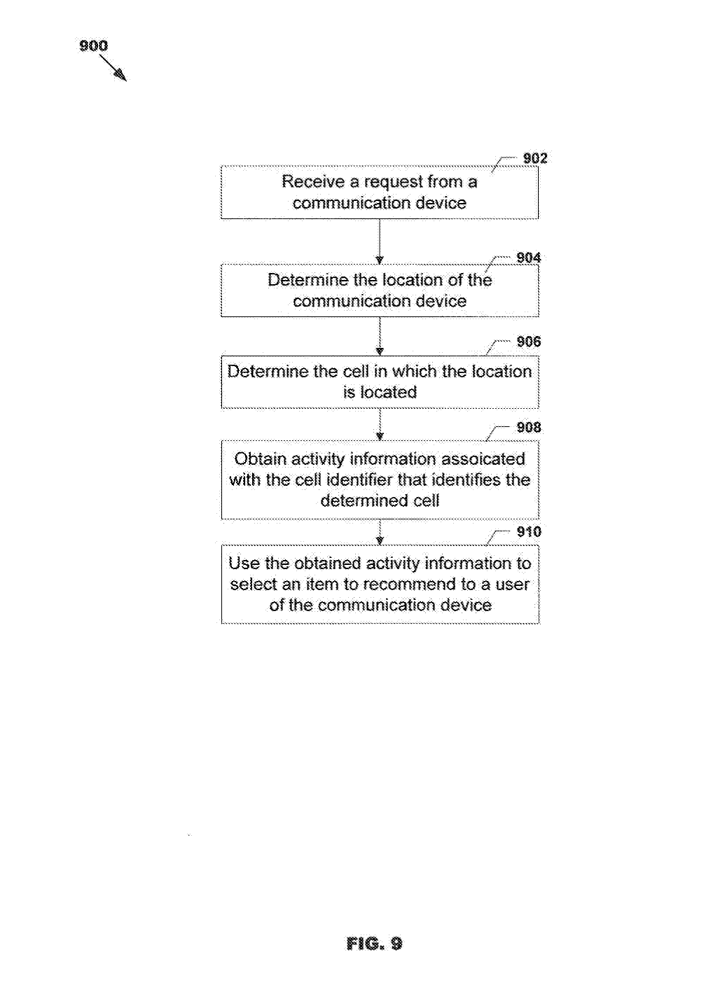

Referring now to FIG. 9, FIG. 9 is a flow chart illustrating a process 900 that may be performed by recommendation engine 210. Process 900 may begin in step 902, where recommendation engine 210 receives a request from a communication device associated with a user, e.g. via a HTTP get message. In step 904, recommendation engine 210 determines the location of the communication device. In step 906, recommendation engine 210 determines the cell in which the location is located. In step 908, recommendation engine 210 obtains (e.g., retrieves from database 208) activity information associated with the cell identifier that identifies the determined cell. In step 910, recommendation engine 210 uses the obtained activity information to select an item to recommend to the user of the communication device, e.g. by sending an HTTP response message to the communication device.

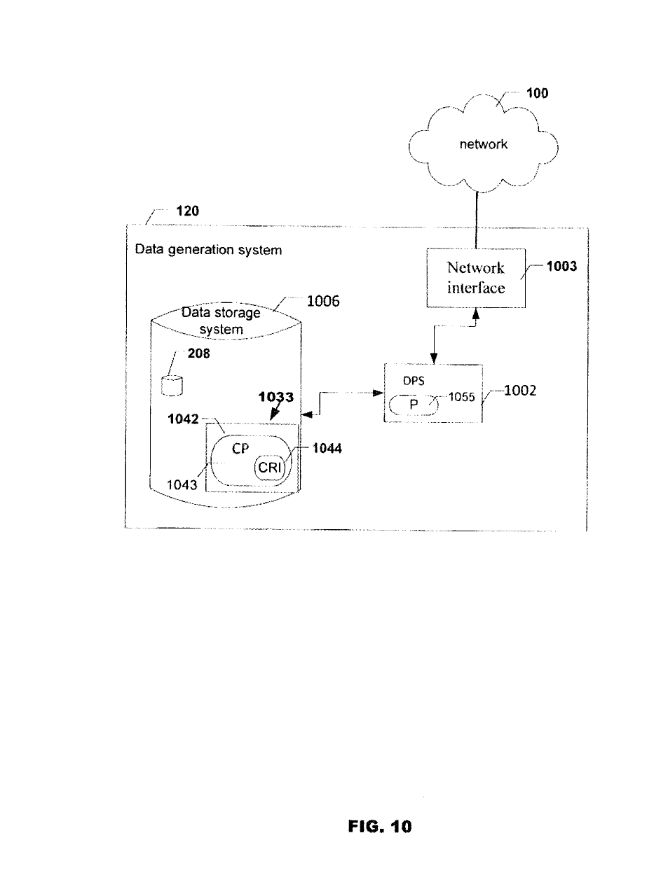

FIG. 10 is a block diagram an embodiment of data generation system (DGS) 120. As shown in FIG. 10, DGS 120 may include: a data processing system (DPS) 1002, which may include one or more processors 1055 (e.g., a general purpose microprocessor) and/or one or more circuits, such as an application specific integrated circuit (ASIC), field-programmable gate arrays (FPGAs), and the like; a network interface 1003 for use in connecting DGS 120 to network 110; and a data storage system 1006, which may include one or more non-volatile storage devices and/or one or more volatile storage devices (e.g., random access memory (RAM)). As illustrated, data storage system 1006 may store database 208. In embodiments where DPS 1002 includes a processor 1055, a computer program product (CPP) 1033 may be provided. CPP 1033 includes a computer readable medium (CRM) 1042 storing a computer program (CP) 1043 comprising computer readable instructions (CRI) 1044. CRM 1042 may be a non-transitory computer readable medium, such as, but not limited, to magnetic media (e.g., a hard disk), optical media (e.g., a DVD), memory devices (e.g., random access memory), and the like. In some embodiments, the CRI of computer program 1043 is configured such that when executed by data processing system 1002, the CRI causes DGS 1002 to perform steps described above (e.g., steps described above with reference to the flow chart shown in FIGS. 3, 4 and 6-8). In other embodiments, DGS 120 may be configured to perform steps described herein without the need for code. That is, for example, data processing system 1002 may consist merely of one or more ASICs. Hence, the features of the embodiments described herein may be implemented in hardware and/or software.

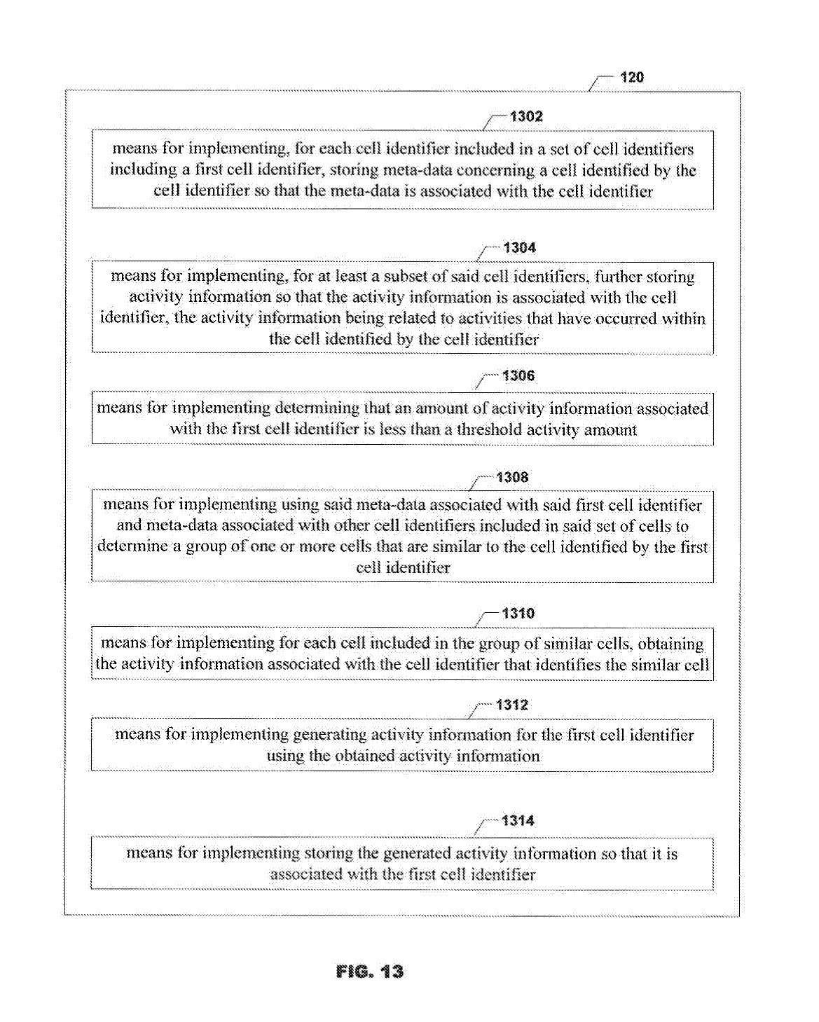

FIG. 13 illustrates the data generation system 120 according to an embodiment, which comprises means 1302 for implementing, for each cell identifier included in a set of cell identifiers including a first cell identifier, storing meta-data concerning a cell identified by the cell identifier so that the meta-data is associated with the cell identifier; means 1304 for implementing, for at least a subset of said cell identifiers, further storing activity information so that the activity information is associated with the cell identifier, the activity information being related to activities that have occurred within the cell identified by the cell identifier; means 1306 for implementing determining that an amount of activity information associated with the first cell identifier is less than a threshold activity amount; means 1308 for implementing using said meta-data associated with said first cell identifier and meta-data associated with other cell identifiers included in said set of cells to determine a group of one or more cells that are similar to the cell identified by the first cell identifier; means 1310 for implementing for each cell included in the group of similar cells, obtaining the activity information associated with the cell identifier that identifies the similar cell; means 1312 for implementing generating activity information for the first cell identifier using the obtained activity information; and means 1314 for implementing storing the generated activity information so that it is associated with the first cell identifier. The means could here be computer program code means which when run by the data generation system 120 causes the computer to perform the corresponding actions enabled by the means.

While various embodiments of the present invention have been described above, it should be understood that they have been presented by way of example only, and not limitation. Thus, the breadth and scope of the present invention should not be limited by any of the above-described exemplary embodiments. Moreover, any combination of the above-described elements in all possible variations thereof is encompassed by the invention unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be rearranged, and some steps may be performed in parallel.

Furthermore, while data generation system 120 has been described in connection with recommendation system 112, this was done merely for illustration because, as described above, data generation 120 need not be a component of or function together with a recommendation system. For example, in other embodiments, data generation system 120 can be used with systems that: i) show top lists of an area; ii) use top lists and statistics for presenting most relevant information first (examples of such occasions are where there is too much information to present on a small screen); and iii) provide a search tool. With respect to search tools, if a user is searching for a particular item (e.g., thing or place) using a search tool, those items with the highest predicted relevance for the location (cell Id) would be shown first. An example of this is would be when an ad company wants to display something at a university campus with no history data collected from, they would base the ads filtering on other university campuses usage patterns. Another example would be if a user is searching for a term but spells the term wrong, the search engine could instead use the metadata about the location (being e.g. a university campus) and relate it to other search terms in places with history data and suggest a corrected spelling of the term to create a better smoother and leaner service for the user of the system. Yet another example is that the data generation system 120 could be used in a system for determining and/or predicting application/s usage for a given area/cell in order to determine future or current demands on a network to be able to provide the right quality of service network performance within an area/cell where certain applications are likely to be used. In other words, the data generation system 120 can be used in for example an Operations Support System (OSS).

1. A method for generating activity information for a cell, the method being performed by a data processing system comprising a processor and the method comprising:
for each cell identifier included in a set of cell identifiers, storing meta-data concerning a cell identified by the cell identifier so that the meta-data is associated with the cell identifier;
for at least a subset of said set of cell identifiers, further storing activity information so that the activity information is associated with the cell identifier, the activity information being related to activities that have occurred within the cell identified by the cell identifier;
determining that an amount of activity information associated with a first cell identifier included in said set of cell identifiers is less than a threshold activity amount;
using said meta-data associated with said first cell identifier and meta-data associated with other cell identifiers included in said set of cells to determine a group of one or more cells that are similar to the cell identified by the first cell identifier;
for each cell included in the group of similar cells, obtaining the activity information associated with the cell identifier that identifies the similar cell;
generating activity information for the first cell identifier using the obtained activity information; and
storing the generated activity information so that it is associated with the first cell identifier.

2. The method of claim 1, wherein each cell identifier included in said set of cell identifiers is a character string formed by encoding a geographic coordinate.

3. The method of claim 1, further comprising:
receiving from a wireless communication device, WCD, an application activity item, the application activity item comprising: a) an application identifier identifying an application used by a user of the WCD, b) location information identifying a location of the WCD at the time the user of the WCD used the identified application, and c) a timestamp identifying a point in time at which the user of the WCD used the identified application in the identified location.

4. The method of claim 3, further comprising;
after receiving the application activity item, using the location information to select from said set of cell identifiers one of the cell identifies; and
after selecting the cell identifier, storing the application identifier and timestamp so that they are associated with the selected cell identifier.

5. The method of claim 1, wherein storing meta-data concerning the cell identified by the cell identifier comprises storing a cell type value.

6. The method of claim 5, wherein storing meta-data concerning the cell identified by the cell identifier further comprises storing a set of usage intensity values, each said usage intensity value being associated with a period of the day.

7. The method of claim 1, wherein
the obtained activity information comprises: a first value associated with a certain activity that occurred within a first cell included in the group and a second value associated with a certain activity that occurred within a second cell included in the group, and
generating the activity information comprises calculating a value using the first and second values.

8. The method of claim 1, further comprising using the generated activity information to select an item to recommend to a user located in the cell identified by the first cell identifier.

9. The method of claim 1, wherein determining that an amount of activity information associated with the first cell identifier is less than a threshold activity amount consists of determining that no activity information is associated with the first cell identifier.

10. The method of claim 9, wherein
the method further comprises determining a likelihood, L, that the cell identified by the first cell identifier has an amount of activity and determining that L exceeds a threshold, and
generating activity information for the first cell identifier using the obtained activity information is performed as a result of i) determining that L exceeds the threshold and ii) determining that an amount of activity information associated with the first cell identifier is less than a threshold activity amount.

11. An apparatus for generating activity information for a cell, the apparatus comprising:
a data storage system storing a cell database, the cell database for storing: i) a set of cell identifiers, including a first cell identifier, each cell identifier included in said set identifying a cell, ii) for each of said cell identifiers, meta-data concerning the cell identified by the cell identifier so that the meta-data is associated with the cell identifier, and iii) for at least a subset of said cell identifiers, activity information so that the activity information is associated with the cell identifier, the activity information being related to activities that have occurred within the cell identified by the cell identifier; and
a data processing system comprising a processor, wherein the processor is adapted to:
determine that an amount of activity information associated with the first cell identifier is less than a threshold activity amount;
use said meta-data associated with said first cell identifier and meta-data associated with other cell identifiers included in said set of cells to determine a group of one or more cells that are similar to the cell identified by the first cell identifier;
for each cell included in the group of similar cells, obtain the activity information associated with the cell identifier that identifies the similar cell;
generate activity information for the first cell identifier using the obtained activity information; and
store the generated activity information so that it is associated with the first cell identifier.

12. The apparatus of claim 11, wherein each cell identifier included in said set of cell identifiers is a character string formed by encoding a geographic coordinate.

13. The apparatus of claim 11, further comprising:
a network interface for receiving an application activity item, the application activity item comprising: a) an application identifier identifying an application used by a user of a wireless communication device, WCD, b) location information identifying a location of the WCD at the time the user of the WCD used the identified application, and c) a timestamp identifying a point in time at which the user of the WCD used the identified application in the identified location.

14. The apparatus of claim 13, wherein the processor is configured to: use the location information to select from said set of cell identifiers one of the cell identifies; and store the application identifier and timestamp so that they are associated with the selected cell identifier.

15. The apparatus of claim 11, wherein
the obtained activity information comprises: a first value associated with a certain activity that occurred within a first cell included in the group and a second value associated with a certain activity that occurred within a second cell included in the group, and
the processor is configured to generate the activity information by calculating a value using the first and second values.

16. The apparatus of claim 11, wherein the apparatus is configured to use the generated activity information to select an item to recommend to a user located in the cell identified by the first cell identifier.

17. The apparatus of claim 11, wherein determining that an amount of activity information associated with the first cell identifier is less than a threshold activity amount consists of determining that no activity information is associated with the first cell identifier.

18. The apparatus of claim 17, wherein
the processor is further configured to determine a likelihood, L, that the cell identified by the first cell identifier has an amount of activity and determining that L exceeds a threshold, and
generate the activity information for the first cell identifier using the obtained activity information as a result of i) determining that L exceeds the threshold and ii) determining that an amount of activity information associated with the first cell identifier is less than a threshold activity amount.

19. A computer program product comprising a non-transitory computer readable medium storing a computer program for generating activity information for a cell, the computer program comprising computer readable instructions which when run on a data generation system causes the data generation system to:
for each cell identifier included in a set of cell identifiers, store meta-data concerning a cell identified by the cell identifier so that the meta-data is associated with the cell identifier;
for at least a subset of said set of cell identifiers, further store activity information so that the activity information is associated with the cell identifier, the activity information being related to activities that have occurred within the cell identified by the cell identifier;
determine that an amount of activity information associated with a first cell identifier included in said set of cell identifiers is less than a threshold activity amount;
use said meta-data associated with said first cell identifier and meta-data associated with other cell identifiers included in said set of cells to determine a group of one or more cells that are similar to the cell identified by the first cell identifier;
for each cell included in the group of similar cells, obtain the activity information associated with the cell identifier that identifies the similar cell;
generate activity information for the first cell identifier using the obtained activity information; and
store the generated activity information so that it is associated with the first cell identifier.

20. (canceled)

21. A data generation system comprising a processor and memory, said memory containing instructions executable by said processor whereby said data generation system is operative to:
for each cell identifier included in a set of cell identifiers including a first cell identifier, storing meta-data concerning a cell identified by the cell identifier so that the meta-data is associated with the cell identifier;
for at least a subset of said cell identifiers, further storing activity information so that the activity information is associated with the cell identifier, the activity information being related to activities that have occurred within the cell identified by the cell identifier;
determining that an amount of activity information associated with the first cell identifier is less than a threshold activity amount;
using said meta-data associated with said first cell identifier and meta-data associated with other cell identifiers included in said set of cells to determine a group of one or more cells that are similar to the cell identified by the first cell identifier;
for each cell included in the group of similar cells, obtaining the activity information associated with the cell identifier that identifies the similar cell;
generating activity information for the first cell identifier using the obtained activity information; and
storing the generated activity information so that it is associated with the first cell identifier.

22. (canceled)
